(19) United States
(12) Patent Application Publication
(10) Pub. No.: US 2026/0212401 A1
(43) Pub. Date: Jul. 23, 2026

(54) SALES SUPPORT DEVICE, SALES SUPPORT METHOD, AND RECORDING MEDIUM

(71) Applicant: NEC Corporation, Tokyo (JP)

(72) Inventor: Satoshi TAKEI, Tokyo (JP)

(73) Assignee: NEC Corporation, Tokyo (JP)

(21) Appl. No.: 19/434,379

(22) Filed: Dec. 29, 2025

(30) Foreign Application Priority Data
Jan. 20, 2025 (JP) 2025-007535

(51) Int. Cl. G06Q 30/0601; G06Q 10/02; G06V 40/16

(52) U.S. Cl. CPC G06Q 30/0631; G06Q 10/02; G06Q 30/0643; G06V 40/174

(57) ABSTRACT

A sales support device includes: one or more memories storing instructions; and one or more processors configured to execute the instructions to: acquire identification information of a user and store information of a store visited by the user; extract product information of a product sold at the store based on the store information; and display the product information on an electronic commerce (EC) site logged in to with the identification information.

This application is based upon and claims the benefit of priority from Japanese Patent Application No. 2025-007535, filed on Jan. 20, 2025, the disclosure of which is incorporated herein in its entirety by reference.

### TECHNICAL FIELD

The present disclosure relates to a sales support device, a sales support method, and a recording medium.

### BACKGROUND ART

JP 2022-102221 A describes a server device that provides beneficial information to a customer who has visited a real store. In JP 2022-102221 A, a server device receives store identification information and product identification information obtained by a portable information device from a product shelf label, and provides the portable information device with store product related information associated with the store identification information and the product identification information.

### SUMMARY

An example of the object of the present disclosure is to provide a technology for promoting product sales to a user.

A sales support device according to an aspect of the present disclosure includes: an acquisition means for acquiring identification information of a user and store information of a store visited by the user; an extraction means for extracting product information of a product sold at the store based on the store information; and a display control means for displaying the product information on an electronic commerce (EC) site logged in to with the identification information.

A sales support method according to an aspect of the present disclosure includes: acquiring identification information of a user and store information of a store visited by the user; extracting product information of a product sold at the store based on the store information; and displaying the product information on an electronic commerce (EC) site logged in to with the identification information.

A program according to an aspect of the present disclosure causes a computer to execute processing including: acquiring identification information of a user and store information of a store visited by the user; extracting product information of a product sold at the store based on the store information; and displaying the product information on an electronic commerce (EC) site logged in to with the identification information.

The program may be stored in a non-transitory computer-readable recording medium.

### BRIEF DESCRIPTION OF THE DRAWINGS

FIG. 1 is a diagram illustrating a configuration of a system including a sales support device;

FIG. 2 is a block diagram illustrating a functional configuration of the sales support device;

FIG. 3 is a diagram illustrating an example of an output screen;

FIG. 4 is a flowchart illustrating an operation of the sales support device;

FIG. 5 is a flowchart illustrating an operation of the sales support device;

FIG. 6 is a block diagram illustrating another example of a functional configuration of the sales support device;

FIG. 7 is a flowchart illustrating an operation of the sales support device;

FIG. 8 is a block diagram illustrating another example of a functional configuration of the sales support device;

FIG. 9 is a diagram illustrating an example of an output screen;

FIG. 10 is a flowchart illustrating an operation of the sales support device; and

FIG. 11 is a diagram illustrating a hardware configuration for implementing the sales support device according to the present disclosure in a computer and its peripheral devices.

### EXAMPLE EMBODIMENT

Hereinafter, example embodiments of the present disclosure will be described in detail with reference to the drawings.

### Example Embodiment

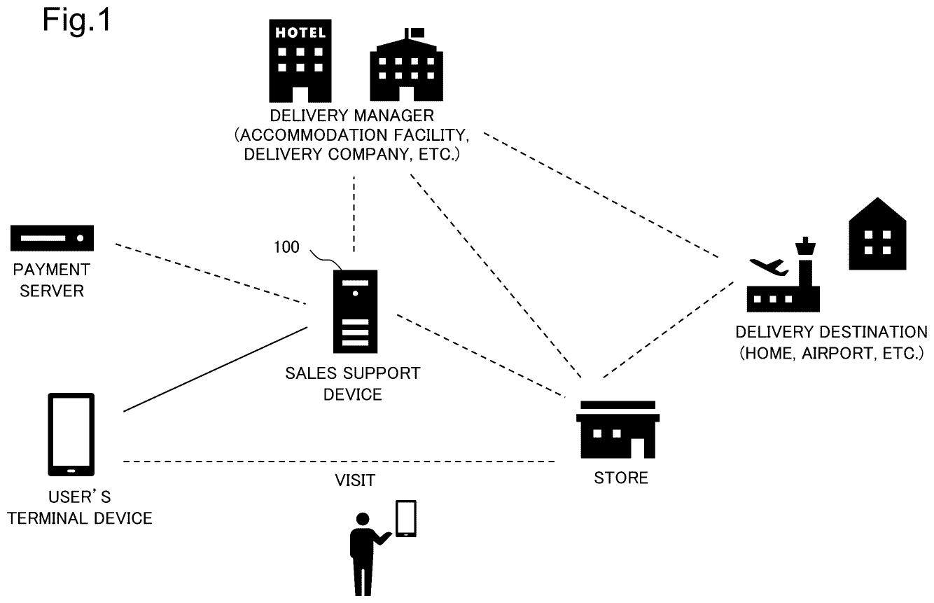

FIG. 1 is a diagram illustrating an example of a system including a sales support device 100 according to the present disclosure.

In FIG. 1, the sales support device 100 is communicably connected to a terminal device of a user. In addition, the sales support device 100 may be communicably connected to a terminal device of, for example, a store that sells products or a business operator that manages delivery of purchased products.

The sales support device 100 is a device that supports product sales to the user by displaying product information of a store visited by the user on the terminal device used by the user.

For example, the sales support device 100 is achieved by a server or a cloud computing system.

For example, the sales support device 100 displays the product information on the terminal device through an application or a website. Here, the application or the website provides, for example, a service that allows a user to browse product information via the Internet or to purchase products via the Internet. An example of a service that allows a user to purchase products via the Internet is an electronic commerce (EC) site.

In the present disclosure, it is assumed that sales support device 100, in particular, displays product information of a product sold at a store visited by the user on a trip or the like.

The store is a store that sells products. For example, the store is a store that sells souvenirs. Furthermore, for example, the store may include a convenience store and a supermarket, and is not particularly limited. The store selling souvenirs may be, for example, a store provided in an accommodation facility or another store in a nearby tourist spot.

In addition, the sales support device 100 may be capable of displaying product information of a plurality of stores. Here, it is assumed that the plurality of stores are stores in the same area such as a tourist spot. The plurality of stores work with the above-described service that allows browsing of the product information and/or the above-described service that allows purchase of products. That is, these services may be implemented as services of one store or as services of a plurality of stores. In a case where they are implemented as services of a plurality of stores, the sales support device 100 is used by, for example, an accommodation facility in an area including a plurality of stores, a local government in an area including a plurality of stores, or a tourism association.

Next, the terminal device of the user is a terminal device that allows the user to browse the product information. For example, the terminal device of the user displays the product information on a site for browsing the product information or an EC site so that the user can browse the product information.

The terminal device of the user may be implemented, for example, by a smartphone, a tablet, or a Personal Computer (PC). The terminal device of the user may be possessed by the user, or, for example, may be provided in an accommodation facility where the user stays at the travel destination or the like.

Next, a configuration of the sales support device 100 according to the example embodiment will be described.

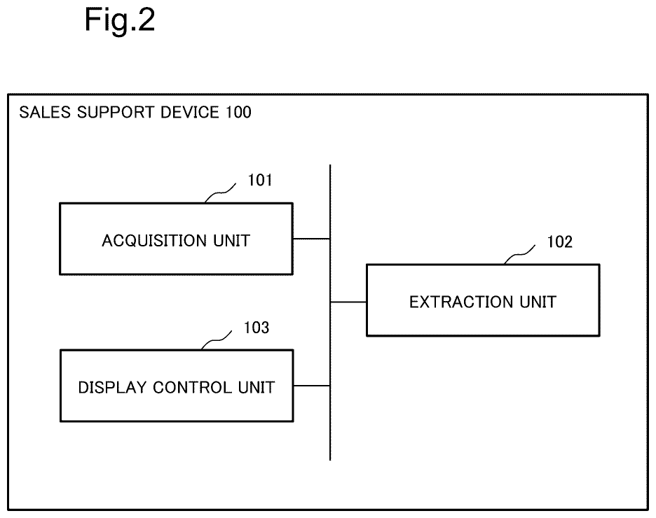

FIG. 2 is a block diagram illustrating a configuration of the sales support device 100. Referring to FIG. 2, the sales support device 100 includes an acquisition unit 101, an extraction unit 102, and a display control unit 103.

Next, the configuration of the sales support device 100 according to the first example embodiment will be described in detail.

The acquisition unit 101 is an example of an acquisition means for acquiring identification information of the user and store information of the store that the user has visited.

The identification information of the user is information used to identify the user. The identification information of the user is, for example, information for identifying the user in a service such as those described above in which the sales support device 100 displays the product information.

The identification information of the user is, for example, member identification information for identifying a member who is the user in a case where users register as members in the above-described service. Furthermore, for example, the identification information of the user may be, for example, face information of the user registered in advance in association with the member identification information.

For example, the acquisition unit 101 acquires the member identification information of the user from the terminal device of the user. Furthermore, for example, the acquisition unit 101 acquires a face image of the user from an image captured in the store. In this case, the acquisition unit 101 may acquire the member identification information of the user associated with the face information of the user matching the face image of the user. Verifying whether the face image of the user captured in the store matches the face information of the user registered in advance may be performed by a verification unit provided inside or outside the sales support device 100 using a known technique.

The store information is information for determining the store visited by the user.

For example, the store information is store identification information. Here, the store identification information is information for identifying a store. For example, the terminal device of the user reads the store identification information, and the acquisition unit 101 acquires the store identification information from the terminal device. The store identification information may be read by a two-dimensional code, near field communication (NFC), or the like. Furthermore, for example, the store identification information may be input by the user through the terminal device of the user.

Another example of the store information is position information of the terminal device of the user. For example, the acquisition unit 101 may acquire the position information from the terminal device of the user, and may acquire the store identification information for store identification of the store if the position indicated by the position information is included in the range of the store position. In this case, for example, the store identification information and the range of the store position may be stored in a database or the like in advance in association with each other.

Another example of the store information is schedule information of the user. The schedule information is information on the user's planned visit to the store. The schedule information is, for example, accommodation information of the user or itinerary information indicating an itinerary of the user. The accommodation information may be acquired from a database of the accommodation facility or the like, or may be acquired from an application or the like that manages a reservation mail for the accommodation facility or a schedule stored in the terminal device of the user.

Note that the acquisition unit 101 may acquire the store information of a plurality of stores that the user has visited.

The extraction unit 102 is an example of an extraction means for extracting the product information of products sold at a store based on the store information. For example, the extraction unit 102 extracts the product information of products sold at the store associated with the store identification information determined from the store information. For example, the extraction unit 102 may extract the product information from a database in which the store identification information and the product information are associated with each other. Furthermore, for example, the extraction unit 102 may extract the product information from a database that stores the product information of each store based on the store identification information. Note that the products sold at a store mean products that were sold at the store when the user visited the store. That is, the products sold at a store mean products that the user saw in the store. Furthermore, the products sold at a store may include products sold at the store visited by the user at the time when the extraction unit 102 extracts the product information.

Note that the extraction unit 102 may extract part or all of the product information sold at the store identified from the store information. For example, the extraction unit 102 extracts the product information of products that can be sold on an EC site among the product information of the products sold at the store. In this case, for example, a flag indicating that a product can be sold or cannot be sold at the EC site may be added to the product information of each product.

The display control unit 103 is an example of a display control means for displaying the product information extracted by the extraction unit 102 on the EC site logged in to with the identification information of the user. For example, the display control unit 103 performs control in the terminal device of the user to display the product information on the EC site logged in to with the identification information of the user. The manner in which it is displayed is not particularly limited.

The display control unit 103 may end the display of the product information at a time according to the end of the user's stay in the area including the store. By ending the display of the product information of the store visited by the user, it is possible to allow the user to browse or purchase products only during the stay in the area including the store visited by the user. As a result, for example, it is possible to achieve the convenience of being able to browse the product information of products sold at a store and purchase them, while maintaining the user's high willingness to purchase created by the rarity of the purchase experience of products that can be purchased only during the stay.

The time according to the end of the stay is a predetermined time before or after the end of the stay in the area including the store visited by the user.

For example, the time according to the end of the stay is a predetermined time before the end of the stay. An example of the predetermined time before the end of the stay is a predetermined time at night before the end of the stay. As another example, the predetermined time before the end of the stay may be set to, for example, a time before the end of the stay at which the user receives luggage deposited at the accommodation facility or the like and can receive a product purchased by the user.

In this way, by allowing the user to purchase a product until the predetermined time before the end of the stay, the product purchased by the user can be received in the area including the store visited by the user. In this case, the delivery destination of the product purchased on the EC site can be set to an accommodation facility where the user is staying, or a station, an airport, or the like used when the user returns home. For example, in a case where the user lives at a far place, this may reduce the cost of long-distance delivery to the user's home or the like.

As another example, the time according to the end of the stay may be the time at which the stay ends. The time at which the stay ends is, for example, the time at which it is detected that the user's movement has caused the position information to move out of the area including the store visited by the user. As another example, the time according to the end of the stay is a predetermined time after the end of the stay. The predetermined time after the end of the stay is, for example, the time at which a predetermined period has elapsed since the end of the stay.

Furthermore, the end of the stay may be the end of the stay in the area including the store visited by the user or the end of the stay at the accommodation facility where the user stays. Furthermore, the time at which the stay ends may be the time at which the stay actually ends or a time at which the stay is expected to end.

The time according to the end of the stay may be, for example, a time determined based on the position information of the terminal device of the user. In this case, the display control unit 103 may terminate the display of the product information of the store visited by the user at a time according to the time at which the position information of the terminal device of the user has moved out of the area including the store visited by the user.

Furthermore, for example, the time according to the end of the stay may be the time when a predetermined period has elapsed from the date and time when the user visited the store. In this case, the display control unit 103 may terminate the display of the product information of the store visited by the user at the time when the predetermined period has elapsed from the date and time when the user visited the store. The time at which the predetermined period has elapsed from the date and time when the user visited the store is, for example, the time at which the user is expected to end the stay in the area including the store the user visited.

Furthermore, for example, the time according to the end of the stay may be a time determined based on the schedule information of the user. In this case, the display control unit 103 may terminate the display of the product information of the store visited by the user according to the time of checkout at the accommodation facility where the user stays, the time of reservation of a flight, a train, or the like departing from the area including the store visited by the user, or the like included in the schedule information of the user.

Next, the manner in which the product information is displayed by the display control unit 103 will be described. The manner in which the product information is displayed by the display control unit 103 is not limited to the following examples.

For example, in a case where displaying the product information of a plurality of stores, the display control unit 103 may display the product information for each store. That is, the display control unit 103 displays the product information of each of the products sold at the same store next to one another.

Furthermore, for example, the display control unit 103 may collectively display the product information of a plurality of stores. That is, the display control unit 103 may display the product information regardless of the store where the products are sold. For example, the display control unit 103 displays the product information of each of the products sold at a plurality of stores next to one another for each product category. Note that the display control unit 103 may display the product information for each store or for each product category according to the user's choice. Here, the product category is, for example, a category classified depending on the product type. For example, the product category may be categories such as seasoning, confectionery, liquor, tableware, and miscellaneous goods, but is not limited to these examples. Furthermore, for example, the display control unit 103 may display the product information of each of the products sold at a plurality of stores next to one another for each product price. The order in which the product information is displayed in a case where the display control unit 103 collectively displays the product information of a plurality of stores is not limited to these examples.

Furthermore, the display control unit 103 may display products according to the priority of display of their product information. For example, the display control unit 103 may display products with priority given to local specialties of the area including the store visited by the user. In this case, for example, the display control unit 103 refers to a flag indicating that the product is a local specialty assigned in advance to the product information, and displays local specialties with higher priority.

Displaying with higher priority may be, for example, emphasizing the product information of certain products, assigning higher display order numbers to the products, displaying their product information with an increased size, or displaying their product information in a fixed position in a case where the product information is scrollable. Here, local specialties are products manufactured or sold only in the area. By displaying the priority level of local specialties with higher priority, a user who has visited for travel or the like can know products unique to the area, which may improve the user's willingness to purchase.

Furthermore, the display control unit 103 may display a condition under which a product can be purchased together with the product information. For example, the condition under which the product can be purchased is that the product can be purchased until the time according to the end of the stay. The display control unit 103 may display one condition as the condition under which products can be purchased, or may display a different condition for each product or each store.

In addition, the condition under which the product can be purchased may be based on the delivery destination of the product. For example, the condition under which a product can be purchased based on the delivery destination of the product may include the time, the time of day, or the position information of the terminal device of the user at which the product can be purchased for each delivery destination, or may include the delivery fee for each delivery destination.

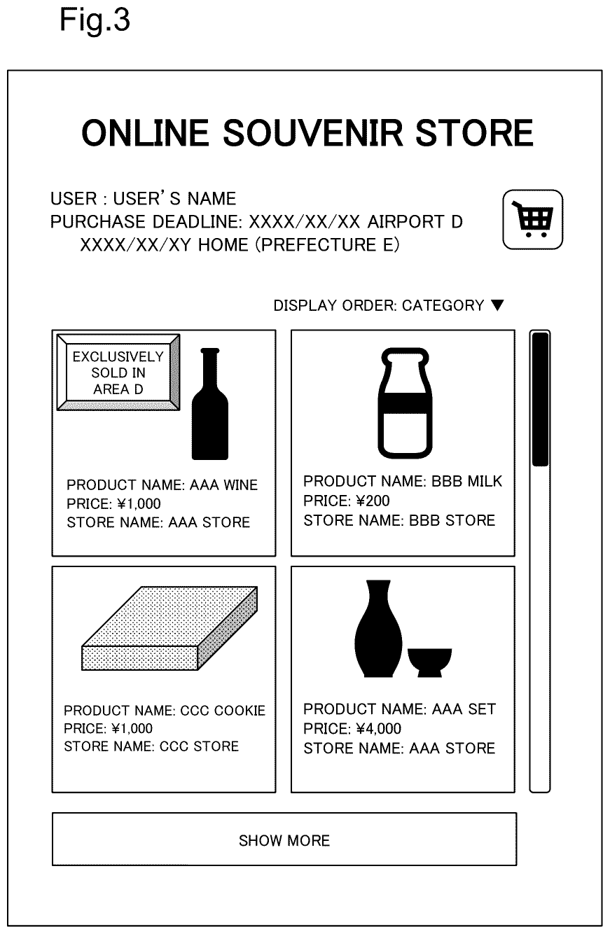

FIG. 3 is an example of a display screen of the product information on the EC site displayed on the terminal device of the user by the display control unit 103. In FIG. 3, the display screen includes the name of the application or website for displaying the product information, and the name of the user who is logged in to the application or website for displaying the product information. Furthermore, in FIG. 3, the display screen includes a purchase deadline for each delivery destination of the user. In FIG. 3, the purchase deadline for each delivery destination of the user includes a purchase deadline in a case where the airport in the area including the store visited by the user is the delivery destination, and a purchase deadline in a case where the user's home is the delivery destination. For example, the purchase deadline in a case where the airport in the area including the store visited by the user is the delivery destination is set to be shorter than the purchase deadline in a case where the user's home is the delivery destination. Note that the purchase deadline is an example of a condition under which the user can purchase the product.

In addition, in an example of the display screen of FIG. 3, the product information of products sold at a plurality of stores is displayed next to one another for each category. For example, in an example of the display screen of FIG. 3, “AAA wine”,“BBB milk”, and “CCC cookie” included in the food category are displayed next to one another, and then, the tableware “AAA set” included in the category of miscellaneous goods is displayed next to them. In addition, the “AAA wine” and “AAA set” are products sold at the same store, but they are in different product categories, namely, food and miscellaneous goods, and thus are not displayed next to one another in a case where the product information is displayed for each product category. Further, in one example of the display screen of FIG. 3, the “AAA wine” that is a local specialty is displayed as “sold exclusively in area D”, which is the area where the store is located, and is displayed earlier in the order.

Note that the display screen of FIG. 3 is one example, and the manner in which the display control unit 103 displays the product information is not limited to this example.

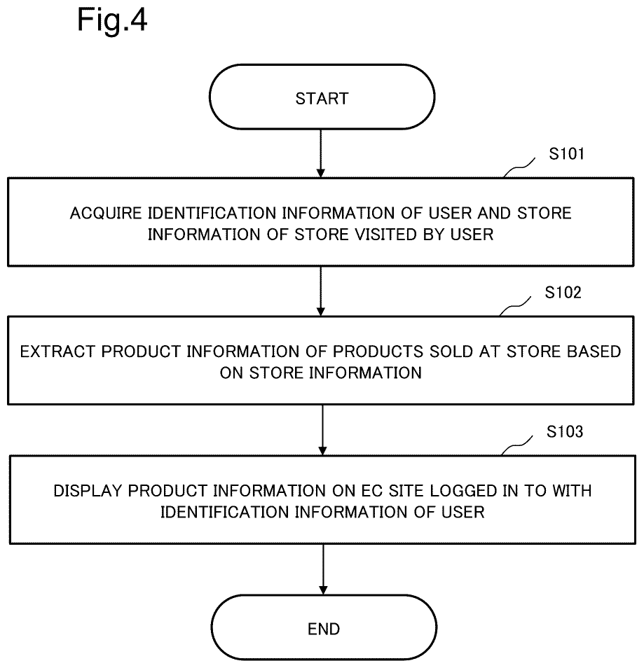

Operation of the sales support device 100 configured as described above will be described with reference to a flowchart in FIG. 4.

First, the acquisition unit 101 acquires the identification information of the user and the store information of a store that the user has visited (step S101).

Next, the extraction unit 102 extracts the product information of a product sold at the store visited by the user based on the store information acquired in step S101 (step S102).

Next, the display control unit 103 displays the product information extracted in step S102 on the EC site logged in to with the identification information of the user acquired in step S101 (step S103).

The sales support device 100 thus ends the series of operations.

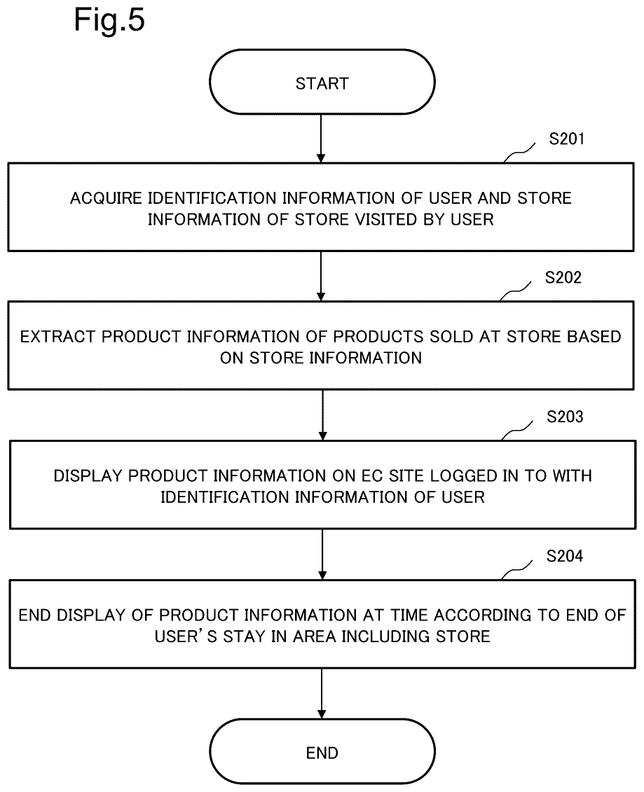

Next, an example of another operation of the sales support device 100 will be described with reference to the flowchart of FIG. 5. The flowchart of FIG. 5 illustrates an example of the operation of the sales support device 100 in a case where the display control unit 103 terminates the display of the product information.

First, the acquisition unit 101 acquires the identification information of the user and the store information of a store that the user has visited (step S201).

Next, the extraction unit 102 extracts the product information of a product sold at the store visited by the user based on the store information acquired in step S201 (step S202).

Next, the display control unit 103 displays the product information extracted in step S202 on the EC site logged in to with the identification information of the user acquired in step S201 (step S203).

Next, the display control unit 103 terminates the display of the product information at a time according to the end of the user's stay in the area including the store (step S204).

The sales support device 100 thus ends the series of operations.

The sales support device 100 in the present example embodiment described above includes the acquisition unit 101, the extraction unit 102, and the display control unit 103. The acquisition unit 101 acquires the identification information of the user and the store information of a store visited by the user. The extraction unit 102 extracts the product information of products sold at the store visited by the user based on the store information. Then, the display control unit 103 displays the extracted product information on the EC site logged in to with the identification information of the user.

With the sales support device 100 according to the present example embodiment, the user can browse the product information of stores visited by the user in places other than the stores, thereby serving as a trigger that motivates the user to purchase products even after leaving the stores. As a result, the sales support device 100 according to the present example embodiment can promote product sales to the user.

### First Modified Example

Next, a first modified example of the present disclosure will be described in detail with reference to the drawings. Hereinafter, the description of content overlapping with the above description will be omitted to the extent that description of the present modified example is not unclear.

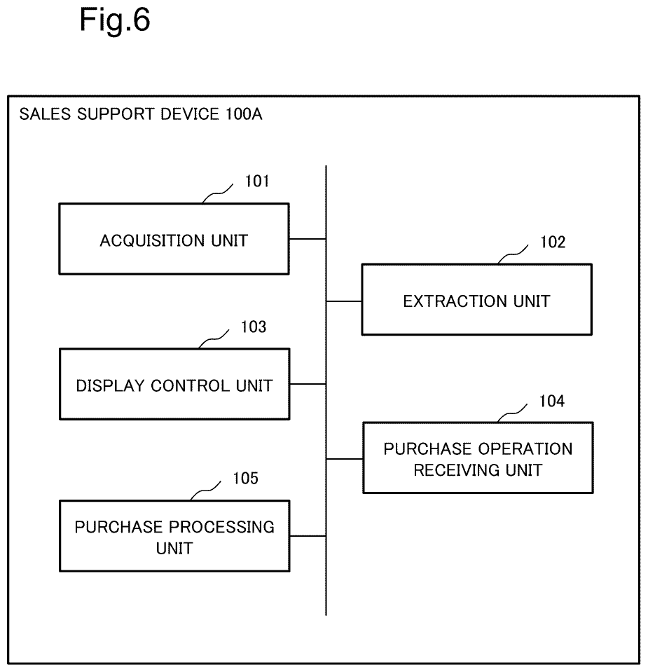

FIG. 6 is a block diagram illustrating a configuration of a sales support device 100A. In FIG. 6, the sales support device 100A includes purchase operation receiving unit 104 and a purchase processing unit 105 in addition to the configuration of the sales support device 100.

The purchase operation receiving unit 104 is an example of a purchase operation receiving means for receiving a product purchase operation from the user. When the user performs a product purchase operation using the terminal device, the purchase operation receiving unit 104 receives the product purchase operation from the terminal device of the user. Receiving the product purchase operation may be acquiring operation information indicating an operation on the terminal device of the user, or may be acquiring the user's input information or selection information determined according to the operation on the terminal device of the user.

For example, the purchase operation receiving unit 104 displays a screen for performing a purchase operation via the display control unit 103, and receives the operation performed on the screen from the terminal device of the user.

The product purchase operation is an operation performed on the EC site for purchasing products. For example, the product purchase operation may be an operation of selecting the product to be purchased, an operation of proceeding to input information regarding product purchase, an operation of determining the purchase of a product, and/or the like. Furthermore, for example, the product purchase operation may include input or selection of payment information, input or selection of the delivery destination, and/or the like. The content of the operation received by the purchase operation receiving unit 104 is not particularly limited, and a known technique for users to purchase products on EC sites may be used.

The purchase processing unit 105 is an example of a purchase processing means for performing the product purchase processing for the user according to the purchase operation. The purchase processing is processing for the user to purchase a product on the EC site, and is, for example, processing for payment for a product, arrangement of a product, or delivery of a product. Here, the purchase processing is not particularly limited, and a known technique related to purchase processing for the user to purchase products on EC sites may be used.

For example, in a case where the purchase processing unit 105 performs the product payment processing, the purchase processing unit 105 performs the payment processing by transmitting the total price of the product purchased by the user and the delivery fee and the payment information of the user to a payment server.

Furthermore, for example, in a case where the purchase processing unit 105 performs the product delivery processing, the purchase processing unit 105 performs the delivery processing by transmitting a request for arranging the product purchased by the user and the delivery destination of the user to a terminal device or the like of a delivery company in charge of the delivery. Note that the product arrangement and the product delivery may be requested to different business operators. For example, the purchase processing unit 105 may request the store where the user has purchased the product to deliver the product purchased by the user to the delivery company, and request the delivery company to receive the product purchased by the user and deliver the product to the delivery destination.

Furthermore, for example, the purchase processing unit 105 may output a notification regarding payment or delivery to the terminal device of the user. The notification regarding payment or delivery is, for example, a notification indicating completion of payment or delivery or a delivery schedule.

Note that the payment information and the delivery destination may be determined by the content received by the purchase operation receiving unit 104, or may be determined based on the accommodation information. In this case, the accommodation information includes payment information for making the payment for use of the accommodation facility, and information on the user's destination, such as a station or an airport to be used or the address of the user's home.

In this case, the purchase processing unit 105 performs the purchase processing based on the accommodation information of the user. For example, the purchase processing unit 105 determines the accommodation information of the user by using the identification information of the user who has logged in to the EC site. The purchase processing unit 105 determines the payment information and the delivery destination from the determined accommodation information. Then, the purchase processing unit 105 performs the payment processing using the determined payment information and the delivery processing to the delivery destination.

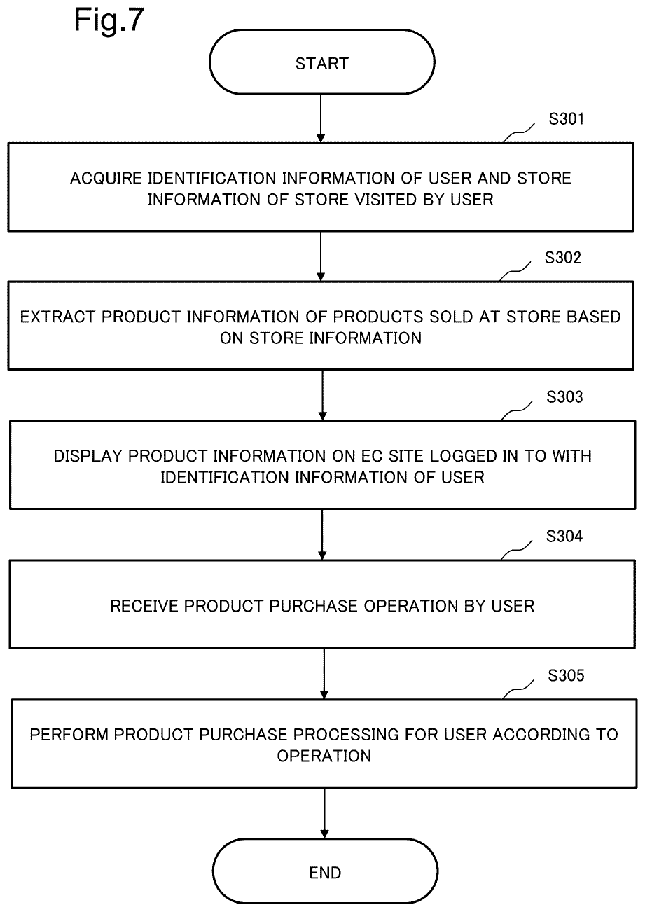

Operation of the sales support device 100A configured as described above will be described with reference to a flowchart in FIG. 7.

First, the acquisition unit 101 acquires the identification information of the user and the store information of a store that the user has visited (step S301).

Next, the extraction unit 102 extracts the product information of a product sold at the store based on the store information acquired in step S301 (step S302).

Next, the display control unit 103 displays the product information extracted in step S302 on the EC site logged in to with the identification information of the user acquired in step S301 (step S303).

Next, the purchase operation receiving unit 104 receives a product purchase operation by the user on the EC site that has displayed the product information in step S303 (step S304).

Then, the purchase processing unit 105 executes the product purchase processing of the user according to the product purchase operation received in step S304 (step S305).

The sales support device 100A thus ends the series of operations.

The sales support device 100A according to the present modified example described above includes the acquisition unit 101, extraction unit 102, display control unit 103, purchase operation receiving unit 104, and purchase processing unit 105. The acquisition unit 101 acquires the identification information of the user and the store information of a store visited by the user. The extraction unit 102 extracts the product information of products sold at the store visited by the user based on the store information. The display control unit 103 displays the extracted product information on the EC site logged in to with the identification information of the user. The purchase operation receiving unit 104 receives a product purchase operation by the user. Then, the purchase processing unit 105 executes the product purchase processing of the user according to the operation received by the purchase operation receiving unit 104.

With the sales support device 100A of the present modified example, the user can purchase the product of stores visited by the user at places other than the store, thereby increasing the opportunity for the user to purchase products. As a result, the sales support device 100A according to the present modified example can promote product sales to the user.

### Second Modified Example

Next, a second modified example of the present disclosure will be described in detail with reference to the drawings. Hereinafter, the description of content overlapping with the above description will be omitted to the extent that description of the present modified example is not unclear.

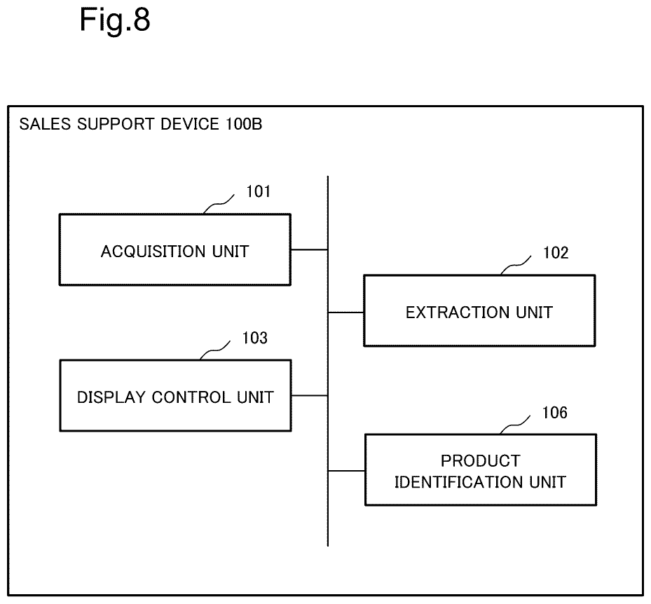

FIG. 8 is a block diagram illustrating a configuration of a sales support device. In FIG. 8, a sales support device 100B includes a product identification unit 106 in addition to the configuration of the sales support device 100.

The product identification unit 106 is an example of a product identification means for identifying a specific product the user reacted to in the store. The display control unit 103 may change the manner in which the product information of the specific product identified by the product identification unit 106 is displayed.

The specific product is a product that the user has reacted to. Here, the user's reaction may be a positive reaction or a negative reaction. The positive reaction is, for example, an affirmative action, expression, or statement by the user regarding the product. The negative reaction is, for example, a negative action, expression, or statement by the user regarding the product.

For example, the product identification unit 106 identifies the specific product the user reacted to based on an image captured in the store. A known technique may be used to identify the user's reaction to a product based on an image. For example, the product identification unit 106 identifies the user from an image captured in the store using the face information of the user registered in advance. For example, the product identification unit 106 identifies the product the user reacted to by comparing an image captured in the store of a product the user looked at, a product the user was looking at for a long time, a product the user picked up, a product a store clerk recommended but was not purchased, or the like, with images of products, or by comparing the position of the user or the user's hand and the position of the product in the image.

Furthermore, the product identification unit 106 may determine whether the reaction of the user is positive or negative based on the user's action or expression in the image. Note that a voice recorded in the store may be further used to identify the reaction to the product. Again, a known technique may be used to identify reactions based on voice. For example, the product identification unit 106 may identify what the user said, the user's tone, or the like based on the voice, and determine whether the reaction is positive or negative.

The product identification unit 106 identifies, for example, a specific product the user reacted to positively. In this case, the display control unit 103 displays the product information of the specific product with high priority. Displaying the product information of the specific product with high priority may be performed in the same manner as in the above example embodiment.

In another example, the product identification unit 106 identifies a specific product the user reacted to negatively. In this case, the display control unit 103 displays the product information of the specific product with low priority. Displaying the product information of the specific product with low priority may be, for example, displaying it later in the order, reducing its display area, or not displaying it.

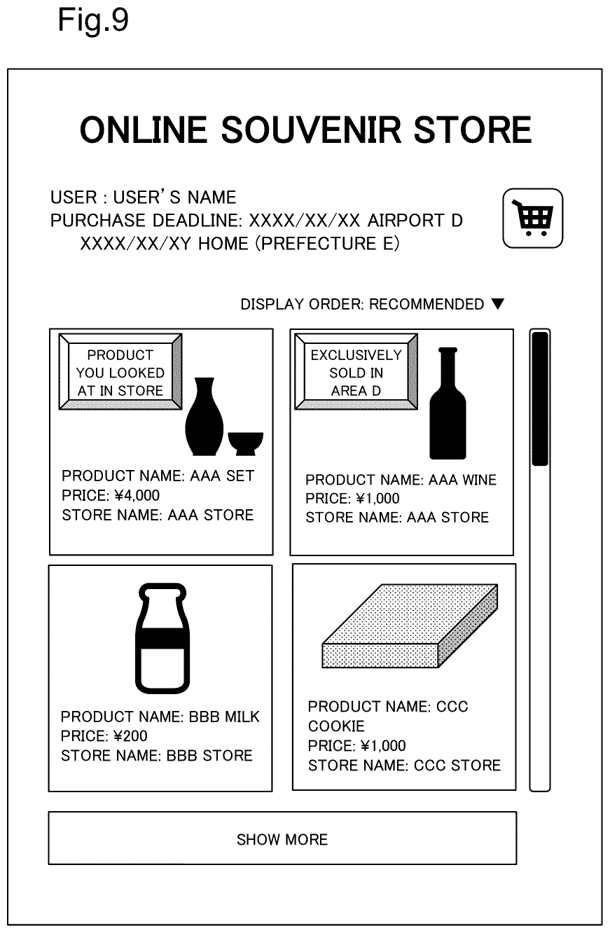

FIG. 9 is an example of a display screen of the product information displayed on the terminal device of the user by the display control unit 103. In FIG. 9, as in FIG. 3, the display screen includes the name of the application or website for displaying the product information, the name of the user who is logged in to the application or website for displaying the product information, and the purchase deadline for each of the user's delivery destinations.

In addition, in an example of the display screen of FIG. 9, the product information of products sold at a plurality of stores is arranged and displayed in order of recommendation. In the recommended order, products the user reacted positively, local specialties of the area including the stores visited by the user, and the like are displayed with high priorities. For example, in the example of the display screen of FIG. 9, since the “AAA set” is a specific product that the user reacted positively in the store, the “AAA set” is displayed earlier in the order than the other products. Furthermore, since the “AAA set” is a specific product that the user reacted positively in the store, the statement “product you looked at in the store” is displayed. Since “AAA wine” is a local specialty, it is displayed earlier in the order, with the statement “sold exclusively in area D”, which is the area where the store is located. Furthermore, in the example of the display screen of FIG. 9, the other products “BBB milk” and “CCC cookie” are displayed next to each other for each category.

Note that the display screen of FIG. 9 is one example, and the manner in which the display control unit 103 displays the product information is not limited to this example. For example, even in a case where the product information is displayed in other manners, such as for each store or category, the display control unit 103 may display these products with high priority.

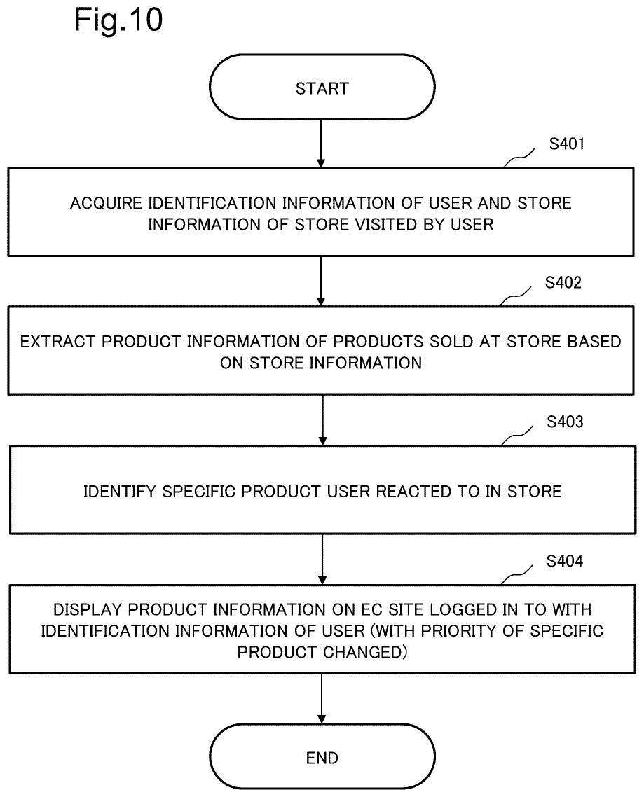

Operation of the sales support device 100B configured as described above will be described with reference to a flowchart in FIG. 10.

First, the acquisition unit 101 acquires the identification information of the user and the store information of a store that the user has visited (step S401).

Next, the extraction unit 102 extracts the product information of a product sold at the store based on the store information acquired in step S401 (step S402).

Next, the product identification unit 106 identifies a specific product the user reacted to in the store (step S403).

Then, the display control unit 103 displays the product information extracted in step S402 on the EC site logged in to with the identification information of the user (step S404). In step S404, the display control unit 103 displays the specific product identified in step S403 with higher priority.

The sales support device 100B thus ends the series of operations.

The sales support device 100B in the present modified example described above includes the acquisition unit 101, the extraction unit 102, the display control unit 103, and the product identification unit 106. The acquisition unit 101 acquires the identification information of the user and the store information of a store visited by the user. The extraction unit 102 extracts the product information of products sold at the store visited by the user based on the store information. The display control unit 103 displays the extracted product information on the EC site logged in to with the identification information of the user. The product identification unit 106 identifies a specific product the user reacted to in the store. Then, the display control unit 103 changes the priority of the specific product and displays it.

With the sales support device 100B according to the present modified example, the user can browse the product information of stores visited by the user in places other than the stores, thereby serving as a trigger that motivates the user to purchase products even after leaving the stores. As a result, the sales support device 100B according to the present modified example can promote product sales to the user.

In addition, the sales support device 100B according to the present modified example displays the product information according to the user's reactions to products in the store. For example, according to the sales support device 100B of the present modified example, a product that the user has reacted positively, that is, a product that the user is likely to purchase is preferentially displayed, or a product that the user has reacted negatively, that is, a product that the user is less likely to purchase is displayed with low priority. As a result, since the user can more easily browse the product information, the sales support device 100B according to the present modified example can promote product sales to the user.

### Hardware Configuration

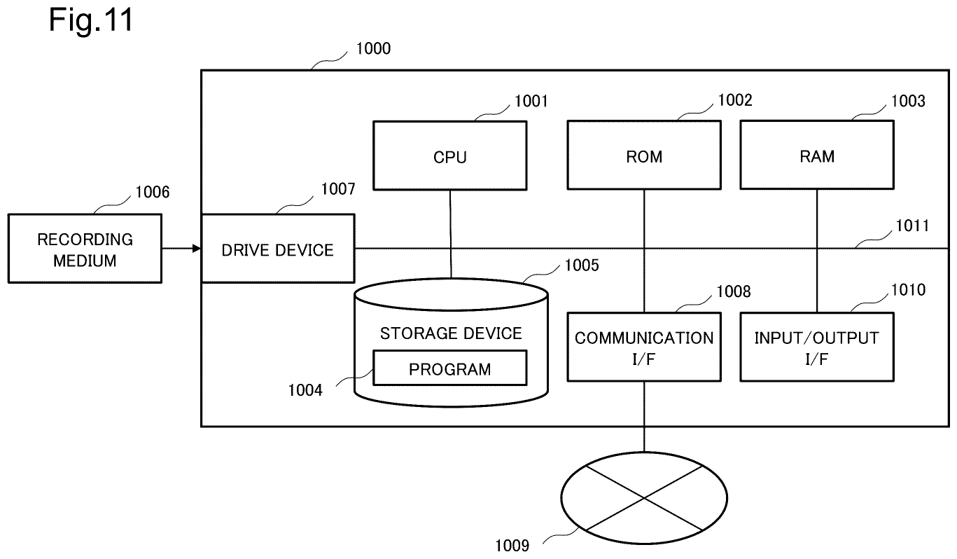

Some or all of the components of each device or system in each example embodiment and modified example of the present disclosure described above are achieved by, for example, any combination of an information processing device 1000 and a program as illustrated in FIG. 11. As an example, the information processing device 1000 includes the following components.
CPU (Central Processing Unit) 1001
ROM (Read Only Memory) 1002
RAM (Random Access Memory) 1003
Program 1004 loaded into the RAM 1003
Storage device 1005 storing the program 1004
Drive device 1007 for reading/writing a recording medium 1006
Communication I/F 1008 connected to a communication network 1009
Input/output I/F 1010 for inputting/outputting data
Bus 1011 connecting components
I/F is an abbreviation of an interface.

The components of each device or system in each example embodiment and modified example are implemented by the CPU 1001 obtaining and executing programs for implementing those functions. For example, the programs for implementing the functions of the components of each device are stored in the storage device 1005 or in the RAM 1003 in advance, and are read by the CPU 1001 as necessary. The program 1004 may be supplied to the CPU 1001 via a communication network, or may be stored in advance in the recording medium 1006 and the drive device 1007 may read the program and supply it to the CPU 1001.

There are various modified examples of the method for achieving each device. For example, each device or system may be achieved by any combination of the information processing device 1000 and the program separate for each component. A plurality of components included in each device may be implemented by any combination of one information processing device 1000 and the program.

Some or all of the components of each device or system are implemented by general-purpose or dedicated circuitry including a processor or the like, or a combination thereof. Examples of the circuitry include a CPU, a graphics processing unit (GPU), a field programmable gate array (FPGA), and a large scale integration (LSI) for artificial intelligence (AI) processing. These may be configured by a single chip, or may be configured by a plurality of chips connected via a bus. Some or all of the components of each device may be implemented by a combination of the above-described circuitry and the like and the program.

There is a technology for providing information such as store-limited products and services and sales promotion events when the user is in a store.

However, the user may wish to browse information on the products of a store or purchase them after leaving the store. For example, even if the user finds a product that the user likes in a store visited during a trip, the user may give up purchasing it on the spot because the additional luggage would make it inconvenient to move around. In such a case, there is a possibility that the store side loses a product sales opportunity.

An example of the effect of the present disclosure is enabling promotion of product sales to the user.

In a case where some or all of the components of each device or system are implemented by a plurality of the information processing devices, circuitry, and the like, the plurality of information processing devices, circuitry, and the like may be arranged in a centralized manner or in a distributed manner. For example, each of the information processing devices, circuitry, and the like may be achieved in the form of a client server system, a cloud computing system, or the like in which they are connected to each other through the communication network.

Although the present disclosure has been described with reference to the example embodiments and the modified examples, the present disclosure is not limited to these example embodiments. It will be understood by those of ordinary skill in the art that various changes in form and details may be made therein without departing from the spirit and scope of the present disclosure as defined by the claims.

For example, the product identification unit 106 included in the sales support device 100B may be changed to be further included in the sales support device 100A.

Although the plurality of operations is described in order in the form of a flowchart, the order of description does not limit the order of executing the plurality of operations. Thus, in a case where each example embodiment and modified example is implemented, the order of the plurality of operations may be changed within a range that does not interfere with the content.

Some or all of the above-described example embodiments and modified examples may be described as, but are not limited to, the following Supplementary Notes.

### Supplementary Note 1

A sales support device including:
an acquisition means for acquiring identification information of a user and store information of a store visited by the user;
an extraction means for extracting product information of a product sold at the store based on the store information; and
a display control means for displaying the product information on an electronic commerce (EC) site logged in to with the identification information.

### Supplementary Note 2

The sales support device according to Supplementary Note 1, wherein the display control means terminates the display of the product information at a time according to the end of stay of the user in an area including the store.

### Supplementary Note 3

The sales support device according to Supplementary Note 2, wherein the time is determined based on position information of a terminal device used by the user.

### Supplementary Note 4

The sales support device according to Supplementary Note 2 or 3, wherein the time is when a predetermined period has elapsed from the date and time when the user visited the store.

### Supplementary Note 5

The sales support device according to any one of Supplementary Notes 2 to 4, wherein the time is determined based on accommodation reservation information of the user.

### Supplementary Note 6

The sales support device according to any one of Supplementary Notes 2 to 5, wherein the display control means further displays the time as a condition under which the product can be purchased.

### Supplementary Note 7

The sales support device according to any one of Supplementary Notes 2 to 6, wherein the display control means further displays a preset delivery destination according to the time.

### Supplementary Note 8

The sales support device according to any one of Supplementary Notes 1 to 7, further including a product identification means for identifying a specific product the user reacted to in the store,
wherein the display control means changes the manner in which the specific product is displayed.

### Supplementary Note 9

The sales support device according to Supplementary Note 8, wherein the specific product is a product the user reacted to positively, and
the display control means displays the product information of the specific product with high priority.

### Supplementary Note 10

The sales support device according to Supplementary Note 8 or 9, wherein the specific product is a product the user reacted to negatively, and

the display control means displays the product information of the specific product with low priority.

### Supplementary Note 11

The sales support device according to any one of supplementary notes 8 to 10, wherein the product identification means identifies the specific product based on an image captured in the store and a face image of the user.

### Supplementary Note 12

The sales support device according to any one of Supplementary Notes 1 to 11, wherein the display control means displays the product information for each of a plurality of stores.

### Supplementary Note 13

The sales support device according to any one of Supplementary Notes 1 to 12, wherein the display control means displays the product information for a plurality of stores for each product category.

### Supplementary Note 14

The sales support device according to any one of Supplementary Notes 1 to 13, wherein the display control means displays a local specialty of an area including the store with high priority.

### Supplementary Note 15

The sales support device according to Supplementary Notes 1 to 14, further including a purchase operation receiving means for receiving a product purchase operation by the user; and
a purchase processing means for performing, in response to the operation, product purchase processing for the user.

### Supplementary Note 16

The sales support device according to Supplementary Note 15, wherein the purchase processing means performs the purchase processing based on the accommodation information of the user.

### Supplementary Note 17

A sales support method including:
acquiring identification information of a user and store information of a store visited by the user;
extracting product information of a product sold at the store based on the store information; and
displaying the product information on an electronic commerce (EC) site logged in to with the identification information.

### Supplementary Note 18

A program that causes a computer to execute processing including:
acquiring identification information of a user and store information of a store visited by the user;
extracting product information of a product sold at the store based on the store information; and
displaying the product information on an electronic commerce (EC) site logged in to with the identification information.

Some or all of the configurations described in Supplementary Notes 2 to 16 dependent on Supplementary Note 1 described above (sales support device) may also be dependent on Supplementary Note 17 (sales support method) and Supplementary Note 18 (program) by a dependency relationship similar to that of Supplementary Notes 2 to 16. Moreover, some or all of the configurations described as the Supplementary Notes can be similarly dependent on not only the Supplementary Notes 1, 17, and 18, but also various pieces of hardware and software, and various recording means or systems for recording software, without departing from the above-described example embodiments.

1. A sales support device comprising:
one or more memories storing instructions; and
one or more processors configured to execute the instructions to:
acquire identification information of a user and store information of a store visited by the user;
extract product information of a product sold at the store based on the store information; and
display the product information on an electronic commerce (EC) site logged in to with the identification information.

2. The sales support device according to claim 1, wherein the one or more processors are configured to execute the instructions to:
terminate the display of the product information at a time according to the end of stay of the user in an area including the store.

3. The sales support device according to claim 2, wherein
the time is determined based on position information of a terminal device used by the user.

4. The sales support device according to claim 2, wherein
the time is when a predetermined period has elapsed from the date and time when the user visited the store.

5. The sales support device according to claim 2, wherein
the time is determined based on accommodation reservation information of the user.

6. The sales support device according to claim 2, wherein the one or more processors are configured to execute the instructions to:
further display the time as a condition under which the product can be purchased.

7. The sales support device according to claim 2, wherein the one or more processors are configured to execute the instructions to:
further display a preset delivery destination according to the time.

8. The sales support device according to claim 1, wherein the one or more processors are configured to execute the instructions to:
further identify a specific product the user reacted to in the store; and
change the manner in which the specific product is displayed.

9. The sales support device according to claim 8, wherein
the specific product is a product the user reacted to positively, and
the one or more processors are configured to execute the instructions to:
display the product information of the specific product with high priority.

10. The sales support device according to claim 8, wherein
the specific product is a product the user reacted to negatively, and
the one or more processors are configured to execute the instructions to:
display the product information of the specific product with low priority.

11. The sales support device according to claim 8, wherein the one or more processors are configured to execute the instructions to:
identify the specific product based on an image captured in the store and a face image of the user.

12. The sales support device according to claim 1, wherein the one or more processors are configured to execute the instructions to:
display the product information for each of a plurality of stores.

13. The sales support device according to claim 1, wherein the one or more processors are configured to execute the instructions to:
display the product information for a plurality of stores for each product category.

14. The sales support device according to claim 1, wherein the one or more processors are configured to execute the instructions to:
display a local specialty of an area including the store with high priority.

15. The sales support device according to claim 1, wherein the one or more processors are configured to execute the instructions to:
further receive a product purchase operation by the user; and
perform, in response to the operation, product purchase processing for the user.

16. The sales support device according to claim 1, wherein the one or more processors are configured to execute the instructions to:
perform the purchase processing based on the accommodation information of the user.

17. A sales support method comprising:
acquiring identification information of a user and store information of a store visited by the user;
extracting product information of a product sold at the store based on the store information; and
displaying the product information on an electronic commerce (EC) site logged in to with the identification information.

18. A non-transitory recording medium storing a program that causes a computer to execute processing comprising:
acquiring identification information of a user and store information of a store visited by the user;
extracting product information of a product sold at the store based on the store information; and
displaying the product information on an electronic commerce (EC) site logged in to with the identification information.
